(19) United States
(12) Patent Application Publication
(10) Pub. No.: US 2013/0200124 A1
(43) Pub. Date: Aug. 8, 2013

(54) CONDIMENT HOLDER FOR VEHICLES

(71) Applicant: BUR-NIE INDUSTRIES, LLC, Blanchester, OH (US)

(72) Inventors: Carol Marie Burwinkel, Blanchester, OH (US); Paul Anthony Niehaus, Cincinnati (OH)

(73) Assignee: BUR-NIE INDUSTRIES, LLC, Blanchester, OH (US)

(21) Appl. No.: 13/757,253

(22) Filed: Feb. 1, 2013

Related U.S. Application Data
(60) Provisional application No. 61/594,649, filed on Feb. 3, 2012.

(51) Int. Cl. B60N 3/10

(52) U.S. Cl. CPC B60N 3/103
USPC 224/545

(57) ABSTRACT

A holder for holding a condiment container includes a frame, a frame support, and an attachment member. The frame defines an opening for removably securing the container. The frame support extends from and is substantially in the same plane as the frame. The attachment member includes a first element spaced apart from a second element. The attachment member may be configured to secure the holder to an air vent of a motor vehicle. The first element may extend from the frame support in a plane defined by the frame support. The attachment member may extend generally perpendicularly from the frame support and may be configured to secure the holder to a vertical surface in a motor vehicle.

### CROSS-REFERENCE TO RELATED APPLICATIONS

This application claims the benefit of U.S. Provisional Patent Application Ser. No. 61/594,649, filed Feb. 3, 2012, and entitled “CONDIMENT HOLDER FOR VEHICLES,” the disclosure of which is hereby incorporated by reference herein in its entirety.

### FIELD OF THE INVENTION

This invention relates generally to removable fixtures or holders.

### BACKGROUND OF THE INVENTION

Most people who enjoy French fries dip their fries in a condiment, such as, ketchup, before eating them. Dipping fries when eating them “in” the food establishment is simple. However, when the French fries are taken “to go,” for eating on-the-go, dipping and then eating fries is more difficult.

Often, taking fries “to go” means eating them in a vehicle. And, when fries are taken “to go,” dipping is often dispensed with because of the limited space available for a container of ketchup in the vehicle and because of the random unexpected motion of the vehicle. The combination of these two factors makes dipping in condiments in vehicles both inconvenient and potentially messy.

There is a need in the art for a device allowing convenient, easy dipping of foods in a condiment when traveling in a vehicle.

### SUMMARY

The present invention overcomes the foregoing. While the invention will be described in connection with certain embodiments, it will be understood that the invention is not limited to these embodiments. On the contrary, the invention includes all alternatives, modifications and equivalents as may be included within the spirit and scope of the present invention.

In one embodiment, a holder for holding a condiment container comprises a frame, a frame support, and an attachment member. The frame defines a frame opening for removably securing a condiment container therein. The frame support extends from and is substantially in the same plane as the frame. The attachment member extends from the frame support opposite the frame opening. The attachment member includes a first element spaced apart from a second element. The first element directly opposes the second element to define a space between the first and second elements. The elements are configured to secure the holder to a motor vehicle.

In one embodiment, the holder is attachable to a louver on air vent in an automobile. The first member extends from the frame support in a plane defined by the frame support, and the second element extends from the frame support parallel to put spaced from the first element along the full length of the second element. The space between the first element and the second element is configured to cooperate with the louver such that the holder projects generally horizontally from the vent.

In one embodiment, the attachment member extends generally perpendicularly from the frame support. The first element is spaced apart from the second element. The second element is selectively positionable, such as, by sliding the second element, along the frame support relative to the first element. The attachment member is configured to secure the holder to a vertical surface in a vehicle, such as, to a pouch or pocket on the rear side of a front seat.

### BRIEF DESCRIPTION OF THE DRAWINGS

The accompanying drawings, which are incorporated in and constitute a part of this specification, illustrate embodiments of the invention and together with a general description of the invention given above, and the detailed description given below, serve to explain various aspects of the invention.

FIG. 1 is a plan view of one embodiment of a condiment holder;

FIG. 1A is an elevation view of the condiment holder shown in FIG. 1;

FIG. 1B is an elevation view of an alternative embodiment of the condiment holder shown in FIG. 1;

FIG. 2 is a plan view of one embodiment of a condiment holder;

FIG. 2A is an elevation view of the condiment holder shown in FIG. 2;

FIG. 2B is an elevation view of an alternative embodiment of the condiment holder shown in FIG. 2;

FIG. 3 is a plan view of one embodiment of a condiment holder;

FIG. 3A is an elevation view of the condiment holder shown in FIG. 3;

FIG. 3B is an elevation view of an alternative embodiment of the condiment holder shown in FIG. 3;

FIG. 4 is a plan view of one embodiment of a condiment holder;

FIG. 4A is an elevation view of the condiment holder shown in FIG. 4;

FIG. 4B is an elevation view of an alternative embodiment of the condiment holder shown in FIG. 4;

FIG. 5A is a perspective view of the embodiment of the holder shown in FIGS. 1 and 1A secured to an exemplary Heating, Ventilation, and Air Conditioning (HVAC) vent; and

FIG. 5B is a perspective view of the embodiment shown in FIGS. 1 and 1B secured to another exemplary location.

### DETAILED DESCRIPTION OF THE INVENTION

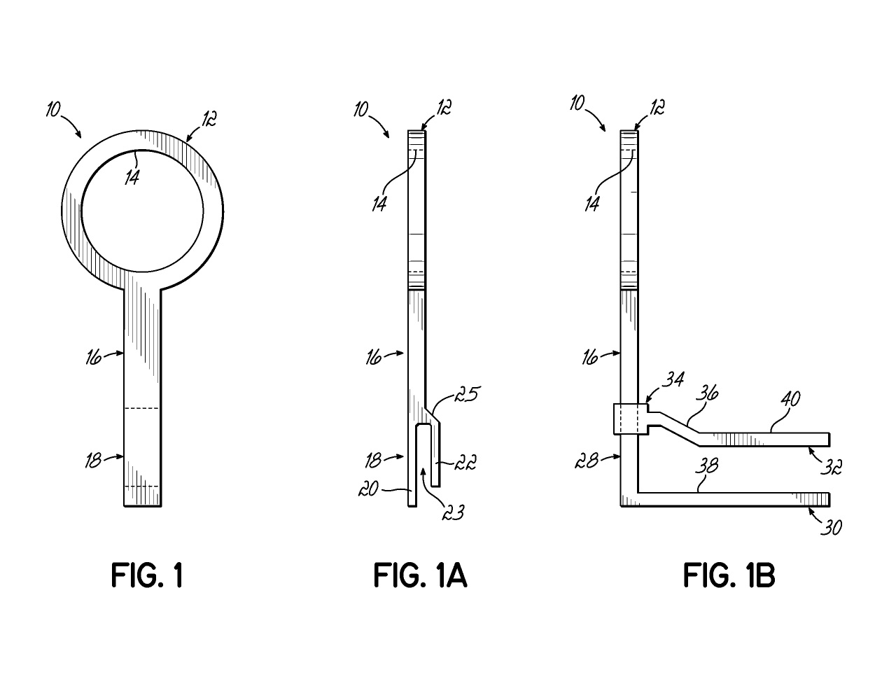

With reference to FIGS. 1-5B generally, there is shown a condiment holder 10 that may be used in a motor vehicle. In the embodiments shown, the holder 10 may include a frame 12 that defines an opening 14. A frame support 16 extends from the frame 12 and may be integral therewith. An attachment member 18, 28 may be formed at one end of the frame support 16 that opposes the frame 12. By way of example only, and not limitation, the holder 10 may be secured in the passenger compartment of an automobile, truck, van, boat, and RV, etc. However, it will be appreciated that the holder 10 may be used in other locations.

To that end, and with reference to FIGS. 1 and 1A, in one embodiment, the frame 12 may be configured to define a substantially circular opening 14 that may cooperate with the cross-sectional configuration of a container (not shown) for holding a condiment, such as, but not limited to, ketchup, mustard, and mayonnaise. The container may include paper or plastic cup-like containers often found in fast-food restaurants or containers used in single-use prepackaged condiments. In this regard, the holder 10, or at least the frame 12, may be made from a plastic or other polymer and are preferably made of a food grade plastic material, as is known in the art.

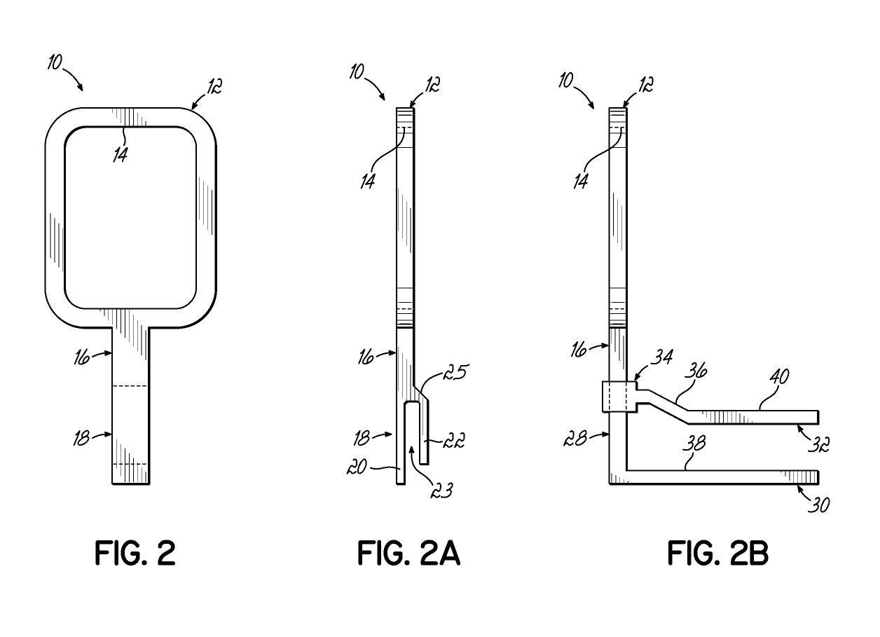

In one embodiment, the opening 14 may be sized to cooperate with an Arby's or Frisch's container. In this regard, in FIG. 1, the holder 10 may be dimensioned with about a 1¼ inch inside diameter. However, the inside diameter may be enlarged to about 1 7/16 inch, with a 2 inch outside diameter, for those holders to be manufactured for different-sized cups, for instance, Frisch's cups. It will be appreciated that the frame 12 may define different shaped openings 14, as shown, for example, in FIGS. 2, 3, and 4 and described below.

With continued reference to FIGS. 1 and 1A, the frame support 16 extends from the frame 12 and may be integral therewith. However, embodiments of the invention are not limited to integral frames 12 and frame supports 16, as these may be separately manufactured and then secured together, such as, by friction fit, by welding, or by gluing. As shown in FIG. 1A, the frame support 16 may extend from and be in substantially the same plane as the frame 12. That is, the frame support 16 and the frame 12 may be of uniform thickness and linearly oriented relative to one another to define a plane.

As shown in FIG. 1A, in one embodiment, the attachment member 18, referred to herein as “clip ‘A’,” is formed at one end of the frame support 16 that opposes the frame 12. The attachment member 18 may be generally U-shaped with a first leg 20 or first element and a second leg 22 or second element spaced apart from the first leg 20. The first leg 20 may extend within the same plane defined by the frame support 16 and the frame 12. The second leg 22 may be offset from the plane defined by the frame support 16 and the frame 12 by an offset member 25. That is, the second leg 22 may be located outside of the plane that is defined by the frame support 16 and the frame 12.

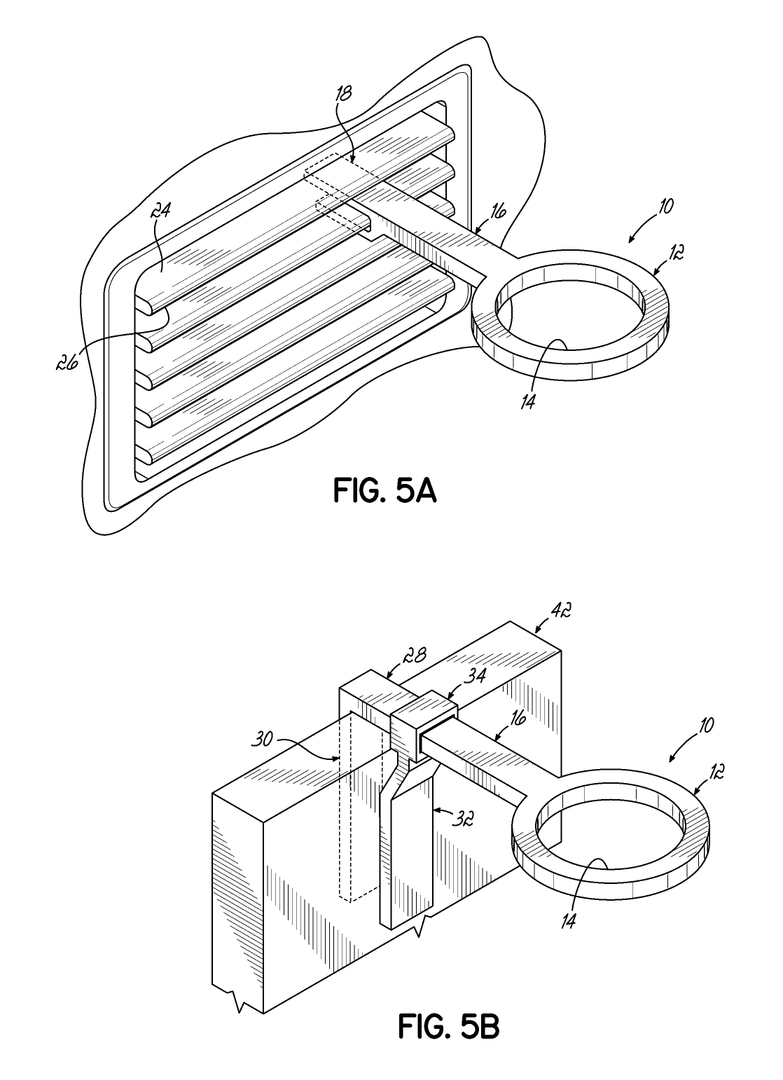

In one embodiment, the first leg 20 directly opposes the second leg 22. A space 23 is defined by the first leg 20 being directly opposed to the second leg 22. As shown, the second leg 22 may be oriented parallel to the first leg 20 along the entire length of the second leg 22, which, in one embodiment, may be shorter than the first leg 20. For example, the difference in the length between the legs 20, 22 may be about 3/16 of an inch. Furthermore, the space 23 between the first and second legs 20, 22 may measure about ⅛ inch. It will be appreciated, however, that the lengths of each leg 20, 22 and the space 23 between the first and second legs 20, 22 may depend on the vehicle on which the holder 10 is to be used. The different lengths of the legs 20, 22 may facilitate or ease insertion of the attachment member 18 into a car air vent as described in more detail below in conjunction with FIG. 5A. Furthermore, it will be appreciated that the dimensions as generally provided herein are merely exemplary.

Referring now to FIG. 5A, the condiment holder 10 with the clip ‘A’ may be inserted into a Heating, Ventilation, and Air Conditioning (HVAC) vent. This may include insertion of the attachment member 18 into vent 24 such that the U-shape defined by the legs 20, 22 cooperates with one louver 26 of the vent 24. When inserted into the vent 24, the frame support 16 extends from the vent 24 so as to position the frame 12 at a position within the vehicle that is accessible to one of the occupants, for example, a driver. A cup or other container (not shown) may be inserted into the opening 14. The rim or other structure of the container may rest or form an interference fit with the frame 12. The container may therefore be held securely in position despite normal movement and vibrations associated with a moving vehicle. When the container is filled with a condiment, the holder 10 may therefore secure the container and position the condiment within easy, convenient reach of the driver or passenger of the vehicle for dipping food, such as, French fries, therein.

With reference now to FIGS. 1 and 1B, in which like reference numerals refer to like features to FIG. 1A, the attachment member 28 or clip portion, referred to herein as “clip ‘B’,” is shown. According to clip ‘B,’ two arms may extend generally perpendicularly from the frame support 16 and generally form an L-shape attachment member. In the exemplary embodiment shown, a first arm 30 or first element extends from and may be integral with the frame support 16. The first arm 30 may extend in a generally perpendicular orientation from the frame support 16. A second arm 32 or second element may be movably secured to the frame support 16 so as to be selectively positionable along the frame support 16 for attaching the holder 10 to a portion of a vehicle.

In this regard, the second arm 32 is movable relative to the first arm 30 allowing the space between the first arm 30 and the second arm 32 to be adjusted. In one embodiment, the second arm 32 may include a collar 34 configured to slidably cooperate with the frame support 16. An occupant of the vehicle may therefore adjustably position the second arm 32 between the frame 12 and the first arm 30 by sliding the collar 34 along the frame support 16 to pinch or clamp an object (not shown) between the first arm 30 and the second arm 32.

In one embodiment, the second arm 32 may further include an offset or dog-leg shaped member 36 to facilitate secure attachment to the object. As shown, the dog-leg shaped member 36 offsets the second arm 32 toward the first arm 30. This offset relationship may be sufficient to ensure that the first arm 30 and the second arm 32 fully engage or pinch any intervening object. In other words, the offset relationship may limit any interference between the collar 34 and the object that may inhibit full engagement of the second arm 32 with the object.

In addition, one or both of the opposing surfaces 38 and 40 may include projections, serrations, or other surface features (not shown) that are configured to facilitate securing the holder 10 to the vehicle. By way of example, one or both of the surfaces 38, 40 of first arm 30 and second arm 32, respectively, may include fine teeth projecting outward. Further, the teeth may be pointed in a direction that aids securing the holder 10 to the vehicle or object to prevent or at least resist unintentional removal of the holder 10 therefrom.

With reference to FIG. 5B, in use, the holder 10 with the attachment member 28 (clip ‘B’) may be secured to the back of a seat, such as, on a pouch or other compartment with a vertical surface or wall 42. In this regard, the holder 10 may be used at locations in which an HVAC vent is not within easy reach. The holder 10 with clip ‘B,’ when secured, may allow food, for example, French fries, to be easily and conveniently dipped in a condiment within a container secured by the holder 10.

In alternative embodiments, it will be appreciated that other attachment members (not shown) may extend from or be integral with the frame support 16, such as, a suction cup (not shown) in lieu of the attachment member 18 or 28 to attach to any flat surface.

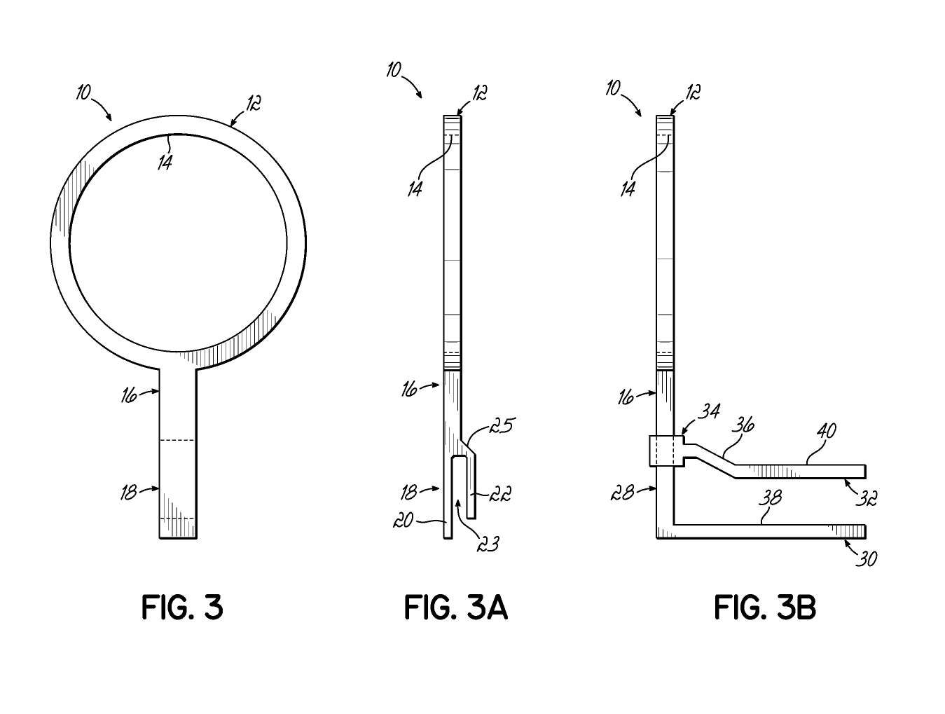

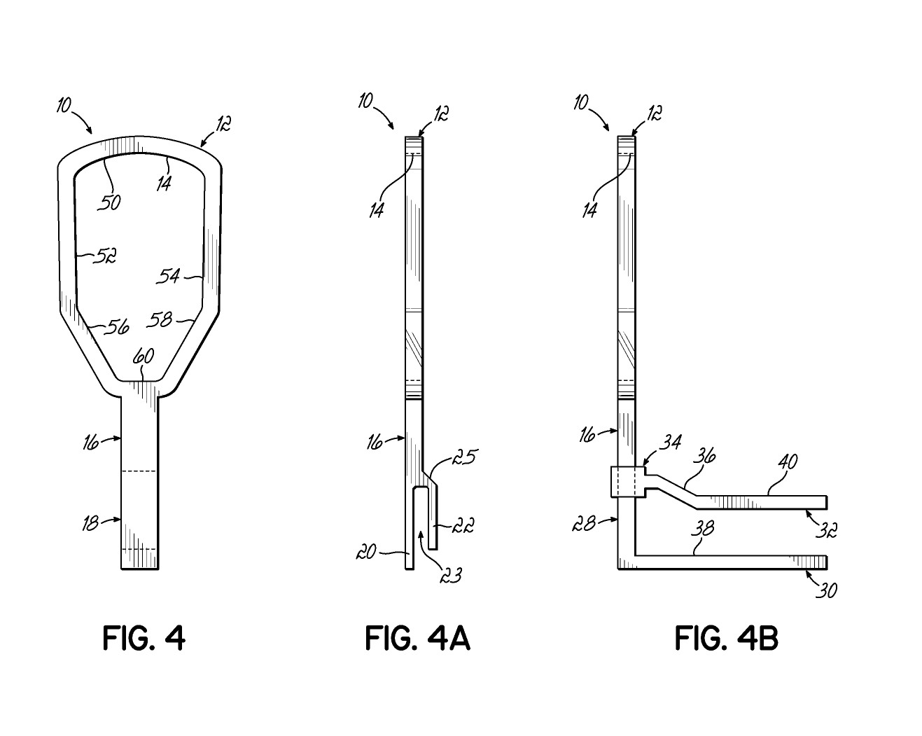

As set forth above, alternative embodiments of the invention are shown in FIGS. 2, 2A, and 2B; FIGS. 3, 3A, and 3B; and FIGS. 4, 4A, and 4B, where like reference numerals refer to like elements of FIGS. 1, 1A, and 1B. As shown in FIGS. 2, 3, and 4, the frame 12 may define a variety of openings 14 for cooperation with specific containers. The exemplary holder shown in FIGS. 2, 2A, and 2B, may be configured to hold a McDonald's sauce container. For example, the holder 10 may be dimensioned such that the opening 14 is approximately 1 5/16 of an inch by approximately 1⅞ of an inch with a ¼ inch radius between the sides. In FIGS. 2A and 2B, the holder 10 may have an overall length of about 3¾ inches and generally have a thickness of about 3/16 of an inch. With reference to FIG. 2A, the frame support 16 may extend from the frame 12 by approximately 9/16 of an inch, though it will be appreciated that a shorter or longer frame support 16 may be used. The first leg 20 may be about 1/16 of an inch thick by about 1 inch in length, whereas the second leg 22 may be about 1/16 of an inch thick by about ¾ of an inch long. The holder 10 shown in FIGS. 2 and 2A with clip ‘A’ may be configured to be attached to a vehicle's HVAC vent in a similar fashion as that shown in FIG. 5A.

The holder 10 shown in FIGS. 2 and 2B with clip ‘B’ may be configured to be attached to the rear of the front seat on the pocket frame or any other projecting surface in a similar fashion as that shown in FIG. 5B. In this regard, the first arm 30 may measure about 2⅛ inches long and may be approximately ⅛ inch thick. The collar 34 may be about ¼ of an inch wide. The second arm 32 may be offset from the collar 34 by approximately ⅛ inch by the dog-leg shaped portion 36, which may extend from the frame support 16 by about 5/16 of an inch with the offset of the dog-leg shaped portion 36 being about ¼ of an inch long.

In one embodiment, as is shown in FIGS. 3, 3A, and 3B, the holder 10 may be configured to hold other containers, for example, miscellaneous home containers. As noted above, the holder 10 shown in FIGS. 3 and 3A, which has the attachment member 18 (clip ‘A’), may be configured to be attached to a vehicle's HVAC vents in a similar fashion as that shown in FIG. 5A. The holder 10 shown in FIGS. 3 and 3B, which has the attachment member 28 (clip ‘B’), may be configured to be attached to the rear of the front seat on the pocket frame or any other projecting surface in a similar fashion as that shown in FIG. 5B. By way of example only, and not limitation, the holder 10 shown in FIG. 3 may be dimensioned such that the opening 14 is approximately 2¼ inches in diameter. The other dimensions of embodiment shown in FIG. 3 may be similar to the dimensions set out above with regard to the embodiment shown in FIG. 2.

In another exemplary embodiment, and with reference to FIGS. 4, 4A, and 4B, the holder 10 may be configured for Heinz Ketchup containers (not shown). Accordingly, the opening 14 defined by the frame 12 may include a 1⅛ inch radius along a first side 50 with opposing sides 52, 54 being approximately 1½ inches long as measured from the apex of the first side 50. A second set of opposing sides 56, 58 may extend at an angle of approximately 30° from the line defined by the frame support 16 to intersect the corresponding opposing sides 52, 54. Side 60 joins the second set of opposing sides 56, 58 opposite the first side 50. The side 60 may measure approximately the same width as the width of the frame support 16. By way of example, the side 60 may measure ⅜ of an inch wide. The remaining dimensions of the embodiments shown in FIGS. 4, 4A, and 4B may be similar to the dimensions set forth with regard to the embodiment shown in FIGS. 2, 2A, and 2B, respectively.

As noted above, the embodiment shown in FIGS. 4 and 4A, which has the attachment member 18 (clip ‘A’), may be configured to be attached to a vehicle's HVAC vents in a similar manner to that shown in FIG. 5A. The holder 10 shown in FIGS. 4 and 4B having the attachment member 28 (clip ‘B’) may be configured to be attached to the rear of the front seat on the pocket frame or any other projecting surface in a similar manner to that shown in FIG. 5B.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. A holder for holding a condiment container, the holder comprising:
a frame disposed in a plane and having a frame opening for removably securing a condiment container therein;
a frame support extending from and being substantially in the same plane as the frame;
an attachment member extending from the frame support opposite the frame opening, the attachment member including a first element and a second element spaced apart from the first element, the first element directly opposing the second element and defining a space between said elements, said elements being configured to secure the holder to a motor vehicle.

2. The holder of claim 1 wherein the holder is attachable to a louver of an air vent in an automobile and wherein the first element extends from the frame support in a plane defined by the frame support, and the second element extends from the frame support parallel to but spaced from the first element along the full length of the second element, the space between the first element and the second element configured to cooperate with said louver such that the holder projects generally horizontally from the vent.

3. The holder of claim 2 wherein the second element is positioned outside of the plane defined by the frame support.

4. The holder of claim 3 further including an offset member extending between the second element and the frame support.

5. The holder of claim 4 wherein the second element is shorter in length than the first element.

6. The holder of claim 2 wherein the attachment member is the same width as the frame support and is narrower than the frame.

7. The holder of claim 1 wherein the attachment member extends generally perpendicularly from the frame support, the first element being spaced apart from the second element, the second element being selectively positionable along the frame support relative to the first element, the attachment member being configured to secure the holder to a vertical surface in a vehicle.

8. The holder of claim 7 wherein the second element includes a collar that slidably engages the frame support.

9. The holder of claim 8 further including a dog-leg shaped member secured to and between the collar and the second element, the dog-leg shaped member offsetting the second element from the first element, the offset being sufficient to position the second element closer to the first element than the collar is to the first element.
